(19) United States
(12) Patent Application Publication
(10) Pub. No.: US 2020/0345032 A1
(43) Pub. Date: Nov. 5, 2020

(54) Enzymatic-Based Process for the Extraction of Value Added Products from Raw Biomasses

(71) Applicant: NATIONAL RESEARCH COUNCIL OF CANADA, Ottawa (CA)

(72) Inventors: Chunzhong YANG, Ottawa (CA); Mark WOOD, Ottawa (CA); Fang HUANG, Ottawa (CA); Theresa DJUKIC, Ottawa (CA)

(73) Assignee: National Research Council of Canada, Ottawa, ON (CA)

(21) Appl. No.: 16/608,409

(22) PCT Filed: Apr. 24, 2018
(86) PCT No.: PCT/CA2018/050480

§ 371 Date: Oct. 25, 2019

Related U.S. Application Data
(60) Provisional application No. 62/489,646, filed on Apr. 25, 2017.

(51) Int. Cl. A23J 1/00; A23J 1/14; A23J 1/12; A23K 10/37; A23K 20/147; A23L 33/17; A23L 33/21

(52) U.S. Cl. CPC A23J 1/005; A23J 1/148; A23J 1/125; A23L 33/21; A23K 20/147; A23L 33/17; A23K 10/37

(57) ABSTRACT

An enzymatic-based process of extracting value added products from oil seed and grain biomasses is described. The process comprises an alkaline pretreatment step followed by treatment with a proteolytic enzyme, and provides increased product yield and solubility. The products obtained can be soluble protein/peptide and purified dietary fiber. The use of such a process in the production of a food, drink, cosmetics, feed or feed additive product is also described.

### CROSS-REFERENCE TO RELATED APPLICATIONS

The present application is a National Stage Entry of International Application No. PCT/CA2018/050480 filed Apr. 24, 2018, which claims the benefit of U.S. provisional application Ser. No. 62/489,646 filed Apr. 25, 2017, the contents of both of which are incorporated herein by reference in their entirety.

### FIELD OF THE INVENTION

The present disclosure relates to processing of biomass from oilseed and grain crops, and more particularly to the separation of proteins from cellulose-hemicellulose fibers in waste products or byproducts from oilseed and other grains.

### BACKGROUND

The processing of oilseed crops and grain feedstocks into useful food and beverage products typically results in a large amount of fiber-based waste or byproducts. Although these waste products contain valuable protein and fiber components, they are of low concentration and purity and therefore are often disposed of as waste and are often costly for processors to remove. Some of the oilseed byproducts are usually used as low value animal feed.

For example, worldwide production of tofu and soymilk from ground soybeans generates millions of tons of a solid by-product called okara each year. Okara is comprised of 75% moisture. On a dry matter basis, okara contains about 50% dietary fiber, 25% protein, 10% lipid, and other nutrients. However, in its wet form, it is fermentable and gets spoiled in a very short time after it is produced due to its high nutritional value and high moisture content. Disposal of large quantities of okara poses a significant environmental and economic problem. Currently, only a very small fraction of okara is used in the food industry or as animal feed after drying. The majority of okara is dumped in the field as a fertilizer or is burned as waste at a cost to both the producer and the environment.

Similarly, current methods of processing corn and barley into useful products such as ethanol results in the production of a fiber-rich byproduct called distillers' dried grains (DDG). Currently, DDGs are mostly used for animal feed as a low value product. Its high value components such as protein and dietary fiber have not been utilized as a food source for human consumption even though some health benefits such as reducing heart disease risk have been reported (Daniel D. Gallaher, 17th Annual Distillers Grains Symposium, May 15-16, 2013; http://www.disfillersqrains.org/files/scholarships/2013%20Daniel%20Gallaher.pdf).

Similarly, a wide range of seed meals from oilseeds such as soybean, cotton, sunflower, canola and flax are used for animal feed as source of protein for most livestock. Historically, some oil seeds such as chia, flax, and hemp have also been consumed by human beings for their claimed health benefits from oil and other components. The oilseed meals of all these crops contain high value proteins mixed with dietary fiber and other components.

However, the protein feeding value cannot be fully utilized when oilseed meal is directly consumed for different reasons. The high temperature process employed during oil extraction decreases the protein solubility of the meal and also reduces nutrition value. For animals such as fish, chickens and young pigs, high levels of fiber dilute the protein and energy content of the meal and have little feeding value. Further, antinutritional factors contained in the oilseed biomasses such as trypsin inhibitor and phytic acid also have negative impact. The existence of trypsin inhibitor activity in animal feed reduces growth rate and protein efficiency ratio (PER) (Wilson and Poe, 1985, Aquaculture, 46: 19-25). Phytic acid is poorly digested by monogastric species such as pigs, chickens and fish. Phytic acid can form complexes with minerals, amino acids and proteins and thereby decrease nutrient digestibility. In addition, the phosphorus in the phytic acid molecule is largely unavailable to the animal and voided with the faeces leading to environmental damage. Overall, oilseed meal or waste, when directly used as a feed component, has limited feeding value as a protein source for monogastric animals such as pigs, chickens and fish due to the high fiber, high antinutritional factor, and high phytate content.

Development of a simple, green technology to separate the valuable proteins from these biomasses has great potential for industrial applications.

For the production of high value protein concentrates and protein isolates from oilseeds such as soybean, different aqueous processing systems and techniques have been developed and commercialized in many cases. However, almost all of the existing processing systems and techniques focus on generating a single high value protein product with little or no consideration given to the value of the non-protein fiber-rich component of the starting material. In addition, current techniques and processing systems for the production of a single high value protein product from oilseeds often consume large amount of water and chemicals such as salts, acid or base to improve protein extraction and isolation efficiency. In addition to water and chemical cost, disposing of low-value by-products or waste streams also leads to extra cost.

U.S. Pat. No. 5,658,714 describes a process for protein extraction from vegetable flour by first adjusting the pH of the extract media to alkaline condition, after concentration, the extracted protein is precipitated by adjusting the pH of the ultrafiltration permeate to 3.5-6.0. U.S. Pat. No. 4,420,425 describes an aqueous extraction process of defatted soybean using alkaline conditions. After removing the solid by filtration, the solubilized protein extract is concentrated by ultrafiltration with a molecular weight cut-off of >100 kD to generate a protein concentrate. U.S. Pat. No. 5,989,600 describes a process to improve vegetable protein solubility with enzymes such as phytase and/or proteolytic enzymes. U.S. Pat. No. 3,966,971 teaches a vegetable protein extraction process by using acid phytase in an aqueous dispersion.

Different procedures have been reported to either isolate the dietary fiber or protein component of okara as a single product using either chemical or enzymatic process. Ma et al (1997, Food Research International, 29 (8):799-805) isolated okara protein by alkaline extraction and isoelectric precipitation. After drying and defatting, the resulting product contains 83% protein. However, the isolated protein has a decreased solubility compared to commercial product, limiting its usefulness in the food industry. The solubility can be improved by a lengthy acid modification process (Chan and Man, 1999, Food Research International 32:119-127), but this two-step procedure (isolate protein and then chemically modify) would lead to increased production costs thus reducing commercialization possibility. In addition, this process only recovered 53% of proteins in okara and did not make use of the fiber-rich component. Protease and phytase combination has been used to improve soy protein solubility (Bae et al., 2013, J. Food Biochemistry, 37:511-519). However, the reported process starts with soy protein isolate and only increases the product solubility in the acidic pH range.

Different procedures have been reported to prepare okara fiber. In one such study (Tian et al, 2007, China Oils and Fats, 32(9):64-66), wet okara was dried, porphyrized, and soaked in alkaline solution followed by enzymatic hydrolysis, bleaching, ethanol precipitation and drying. Surel and Couplet (2005, J Sci Food Agric 85:1343-1349) reported protease hydrolysis of okara protein for the purification of okara fiber. The process included both a protein hydrolysis and defatting step by either chemical reagent or lipase hydrolysis. These processes did not recover the protein content and the complicated steps increase production costs.

The reported procedures for either fiber or protein extraction from okara lead to the waste of the other component and mostly also include the application of strong chemical reagents and organic solvents. In addition, the resulting products are reported to have defects in functionality such as decreased water-holding capacity (WHC) of the fiber or decreased protein solubility. So far, no commercial process has been developed for either of these products and particularly, no procedure has been reported to make full use of this soybean waste to produce both a fiber-rich and a protein-rich product in an integrated mild process.

There is a need to develop a technology that can not only take care of the biomass (e.g., okara) waste disposal issue but also make best use of the valuable components in biomasses (e.g., okara), particularly protein and fiber.

The present description refers to a number of documents, the contents of which are herein incorporated by reference in their entirety.

### SUMMARY OF THE INVENTION

There is provided the following items 1 to 43:
1. A process for producing a protein- and/or peptide-enriched fraction and a dietary fiber-enriched fraction from a biomass comprising;
   a) incubating the biomass in an aqueous solution under mild alkaline conditions and at a temperature of about 85° C. or more to obtain an aqueous slurry;
   b) treating the aqueous slurry with a proteolytic enzyme under conditions suitable for the proteolytic enzyme activity; and
   c) obtaining a liquid fraction and a solid fraction from the proteolytic enzyme-treated slurry of b),
   wherein the liquid fraction is enriched in proteins and/or peptides and the solid fraction is enriched in dietary fibers.
2. The process according to item 1, wherein the biomass is in wet form.
3. The process according to item 1, wherein the biomass is in dry form.
4. The process according to item 3, where the process further comprises grinding the dry biomass prior to step a).
5. The process according to item 4, where the process further comprises passing the ground dry biomass through a mesh, optionally a 50 to 200 μm mesh or a 100 μm mesh.
6. The process according to any one of items 1 to 5, further comprising defatting the biomass prior to step a).
7. The process according to any one of items 1 to 6, wherein the mild alkaline conditions comprises a pH above 7 and not higher than about 11, a pH of about 9 to about 11, or a pH of about 10.
8. The process according to any one of items 1 to 7, wherein step a) is performed at a temperature of about 90° C. to about 100° C.
9. The process according to item 8, wherein step a) is performed at a temperature of about 90° C. to about 95° C.
10. The process according to any one of items 1 to 9, wherein step a) is performed for a period of about 15 minutes to about 2 hours, about 30 to about 90 minutes or about 1 hour.
11. The process according to any one of items 1 to 10, wherein step b) is performed at a pH of about 7 to about 11.
12. The process according to any one of items 1 to 11, wherein step b) is performed at a temperature of about 50° C. to about 80° C.
13. The process according to item 12, wherein step b) is performed at a temperature of about 55° C.
14. The process according to any one of items 1 to 13, wherein step b) is performed for a period of about 15 minutes to about 2 hours, about 30 to about 90 minutes, or about 1 hour.
15. The process according to any one of items 1 to 14, wherein the amount of biomass in the aqueous solution is about 0.5% to about 20% (w/v).
16. The process according to any one of items 1 to 15, wherein the proteolytic enzyme comprises a subtilisin.
17. The process according to item 16, wherein the subtilisin is from Bacillus licheniformis.
18. The process according to any one of items 1 to 17, wherein step c) comprises centrifuging the proteolytic enzyme-treated slurry of b) to obtain the liquid fraction and solid fraction.
19. The process according to any one of items 1 to 18, wherein the process further comprises inactivating the proteolytic enzyme after step b).
20. The process according to item 19, wherein the inactivating is heat inactivating.
21. The process according to item 20, wherein the heat inactivating is performed at a temperature of about 80° C. to about 100° C. for a period of about 5 to about 30 minutes.
22. The process according to any one of items 1 to 21, wherein the process further comprises treating (i) the proteolytic enzyme-treated slurry of b) and/or (ii) the liquid fraction of c), with a solution comprising a divalent cation.
23. The process according to item 22, wherein the solution comprises at least one of CaCl₂, MgCl₂, MnCl₂, and FeCl₂.
24. The process according to item 22 or 23, wherein the process comprises treating the liquid fraction of c) with a solution comprising a divalent cation to precipitate the phytate, and wherein the process further comprises isolating the liquid fraction from the phytate precipitate.
25. The process according to any one of items 22 to 24, wherein the solution comprising a divalent cation is used in an amount of about 1.5 to about 20× equivalents.
26. The process according to any one of items 1 to 25, wherein the process further comprises subjecting the liquid fraction to a size exclusion chromatography or filtration.
27. The process according to any one of items 1 to 26, further comprising concentrating the liquid fraction.
28. The process according to any one of items 1 to 27, wherein the biomass is a grain biomass, a plant biomass, a distillers' dried grains (DDG), a soybean biomass, canola meal or flax seed meal.
29. The process according to item 28, wherein the biomass is a soybean biomass.
30. The process according to item 29, wherein the soybean biomass is okara.
31. The process according to any one of items 1 to 30, further comprising drying the liquid fraction to obtain a protein and/or peptide-rich dry product.
32. The process according to item 31, wherein the protein and/or peptide-rich dry product has a residual trypsin inhibitor activity which is at least 50% lower than a commercial soy protein concentrate (SPC).
33. The process according to item 31 or 32, wherein the protein and/or peptide-rich dry product has a residual phytate content at least 60% lower than a commercial soy protein concentrate (SPC).
34. The process according to item 32 or 33, wherein the commercial SPC is Arcon® F.
35. The process according to any one of items 1 to 34, further comprising drying the solid fraction to obtain a fiber-rich dry product.
36. The process according to item 35, wherein the fiber-rich dry product has a carbohydrate content of about 70% or more and a protein content about 10% or less.
37. A protein and/or peptide-rich dry biomass extract having the following features:
   a) a water solubility of more than 80% over a pH of about 3 to about 11;
   b) a protein and/or peptide content of about 40% or more;
   c) at least 75% of the proteins and/or peptides in the extract have a molecular weight of less than 20 kDa;
   d) a reduced trypsin inhibition activity and phytate content relative to a commercial soy protein concentrate (SPC).
38. The protein and/or peptide-rich dry biomass extract of item 37, wherein said extract has a carbohydrate content of about 20% carbohydrate and/or a lipid content of about 10%.
39. The protein and/or peptide-rich dry biomass extract of item 37 or 38, which is obtained by the process of any one of items 31-33.
40. A fiber-rich dry biomass extract obtained by the process of item 35 or 36.
41. A drink, cosmetic, food, or feed product comprising the protein and/or peptide-rich dry biomass extract of any one of items 37-39 and or the fiber-rich dry biomass extract of item 40.
42. A method of preparing a drink, cosmetic, food, or feed product comprising (i) performing the process of any one of items 31-33 to obtain a protein and/or peptide-rich dry product; and (ii) incorporating said protein and/or peptide-rich dry product to a drink, cosmetic, food, or feed composition.
43. A method of preparing a food or feed product comprising (i) performing the process of item 35 or 36 to obtain a fiber-rich dry product; and (ii) incorporating said fiber-rich dry product to a food or feed composition.

Further features will be described or will become apparent in the course of the following detailed description.

### BRIEF DESCRIPTION OF THE DRAWINGS

In the appended drawings:

FIG. 1 shows a schematic diagram of a method described herein with okara.

FIG. 2 depicts a Coomassie blue-stained SDS-PAGE gel showing the effect of protease E1 concentration on hydrolysis of soybean meal.

FIG. 3 is a graph showing the effect of protease E1 concentration on protein release of soybean meal and okara extractions.

FIG. 4 is a graph showing the protein contents in supernatants and pellets after different extraction steps.

FIG. 5 is a graph depicting the impact of pH and temperature on protein extraction.

FIG. 6 is a graph depicting the impact of pH and temperature on carbohydrate extraction.

FIG. 7A is a graph showing the impact of different proteases on trypsin inhibitor activities in okara extracts. NE=No enzyme; enzymes E1 to E10 are described in Table 4 below.

FIG. 7B is a graph showing the impact of different proteases on trypsin inhibitor activities in soybean meal (SBM). NE=No enzyme; Enzymes E1 to E10 are described in Table 4 below.

FIG. 8 is a graph showing the impact of different concentrations of CaCl₂) on phytate content of okara peptide extract.

FIG. 9 is a graph showing a comparison of the solubility of the okara peptide extract prepared by protease E1 and that of the commercial product Arcon® F.

FIG. 10 depicts a Coomassie blue-stained SDS-PAGE gel of okara and soybean protein extracts.

FIG. 11 depicts Coomassie blue-stained SDS-PAGE gel of hydrolytic supernatants from different biomasses.

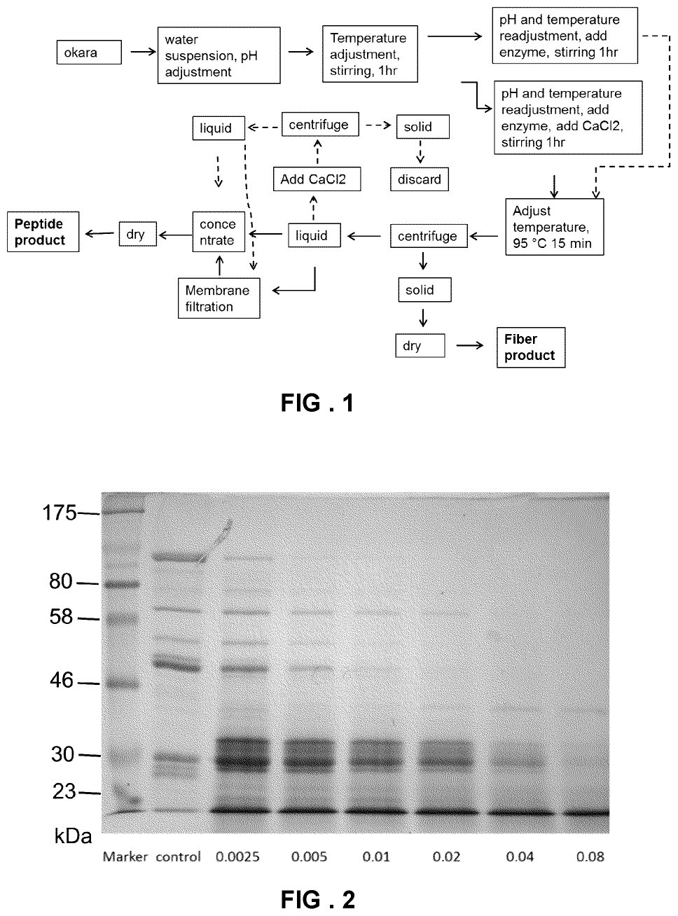

### DETAILED DESCRIPTION OF THE INVENTION

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illustrate the invention and does not pose a limitation on the scope of the invention unless otherwise claimed.

Herein, the term “about” has its ordinary meaning. The term “about” is used to indicate that a value includes an inherent variation of error for the device or the method being employed to determine the value, or encompass values close to the recited values, for example within 10% or 5% of the recited values (or range of values).

Any and all combinations and subcombinations of the embodiments and features disclosed herein are encompassed by the present invention. For example, all combinations and subcombinations of the various embodiments of conditions (temperature, pH, time, etc.) under which the process described herein may be performed are encompassed by the present invention.

The present inventors have developed an enzymatic process to hydrolyze proteins directly from raw biomass after a pretreatment step. A high temperature mild alkaline pretreatment (e.g., ˜60 min, ˜90-95° C., pH ˜10) was performed, which permitted sterilization of the raw material, thus minimizing the risk that the following enzymatic process be contaminated, and also helped solubilize and increase the enzyme accessibility of the protein and fiber biomass, leading to good protein recovery and purified fiber component. Following the pretreatment, the temperature and pH are adjusted to suit the protease function. After the enzymatic reaction (e.g., ˜60 min), most of the proteins were shown to be efficiently hydrolyzed to <20 KDa peptides and/or amino acids, and the solid fraction could be separated from the liquid fraction. The hydrolysis with the selected enzyme was shown to result in reduced trypsin inhibition activity in the soluble product. The soluble product from okara contained much less phytate compared to commercial soy protein concentrate (SPC), and further reduced phytate content in the soluble product, if needed, could be obtained using a divalent cation solution such as CaCl₂), which precipitated most of the remaining phytate. The solid fraction was dried to obtain a fiber-rich product, and the liquid part was concentrated and dried to obtain a protein/peptide-rich product.

The present invention thus relates to a process for producing a protein- and/or peptide-enriched fraction and a dietary fiber-enriched fraction from a biomass comprising:
a) incubating the biomass in an aqueous solution under mild alkaline conditions and at a temperature of about 85° C. or higher to obtain an aqueous slurry;
b) treating the aqueous slurry with a proteolytic enzyme under conditions suitable for the proteolytic enzyme activity; and
c) obtaining a liquid fraction and a solid fraction from the proteolytic enzyme-treated slurry of b),
   wherein the liquid fraction is enriched in proteins and/or peptides and the solid fraction is enriched in dietary fibers.
   Process Development for High Value Product Extraction from Biomass Such as Okara and Soybean Meal

### Soybean Biomasses

Okara is widely available from tofu or soymilk factories in wet form as a waste and also available as a dry product currently used mostly for feed industry and a small fraction for food industry. Soybean meal is also widely available from oilseed processing mills after oil extraction. Such oil extraction may be performed either as a thermomechanical extraction, or a solvent extraction.

### Other Biomasses

The process developed herein may be suitable for the extraction of protein/peptides and/or fibers from other types of biomasses including plant biomass; grain biomass; other biomasses containing a significant amount (˜10% or more) of protein mixed with carbohydrates; aquatic plants such as duckweed and seaweed; and microbial biomasses such as algae, yeasts, fungi and bacteria. As shown in the Examples below, the process was successfully applied to soybean biomasses (SBM, okara) as well as other biomasses including dried distillers' grains (DDG), canola meal, flax seed meal, whole hemp seed, and dehulled hemp seed. Depending on the biomass, the optimal reaction conditions (e.g., pH, temperature, and time) have to be adjusted but were within the ranges defined herein. For all biomasses tested, the protein component was effectively hydrolyzed in a short time and the protein recovery was significantly increased after treatment with the process. For some samples, the protein content in the extracted product was also increased.

In an embodiment, the biomass is in wet form. In another embodiment, the biomass is in dry form.

### Conditions for the Aqueous Extraction Process (AEP):

Using okara and soybean meal as the major starting biomasses, based on the conventional aqueous extraction process, with water suspension under neutral or alkaline conditions, the impact of different factors on the extraction of soluble fraction containing protein as the major component was tested. These factors include: particle size of starting materials, extraction time and temperature; extraction liquid conditions: pH adjustment and buffer system.

Regarding the particle size of starting materials, it was found by the present inventors that even though a rough grinding to break up large pieces may be preferred; a fine grinding step is not needed. For example, for soybean meal, a minimum grinding with particle size more than 1 μm lead to similar effect as fine grinding up to 0.125 μm; similarly, for dried okara, a simple grinding with the particle size ˜1 μm performs equally well compared to finer grinding.

Particularly for soybean meal, reducing the size of the solid soy particles by grinding may be preferred to increase extraction efficiency. The soybean meal is typically ground to a size such that the particles can pass through a No. 100 mesh (U.S. standard) screen.

Thus, in an embodiment, the process defined herein further comprises grinding the biomass (dry biomass) prior to step a). In a further embodiment, the process further comprises isolating the ground particles having a size smaller than about 200, 150, 100, 50, 25 or 10 μm, for example by passing the ground dry biomass through a mesh, preferably a 50 to 200 μm mesh, more preferably a 100 μm mesh.

In an embodiment, the process defined herein further comprises a step of defatting (e.g., removing oil) the biomass prior to step a). Methods for defatting biomass such as soybean biomass (okara) are known in the art. Defatting may be achieved by chemical extraction using suitable solvent or by lipase hydrolysis, for example.

Regarding the impact of extraction time on protein yield, it was found that at room temperature, with time increase, the protein release gradually increased and typically plateaued after ˜60 min. Thus, in embodiments, the pre-treatment step is performed for a period of less than about 2 hours, or less than about 90 minutes, or less than about 75 minutes. In other embodiments, the pre-treatment step is performed for a period of at least 15, at least 20, at least 25, at least 30, at least 35, at least 40 or at least 45 minutes. In further embodiments, the pre-treatment step is performed for a period of about 15 minutes to about 90 minutes, about 30 minutes to about 75 minutes, about 45 minutes to about 75 minutes, about 50 minutes to about 70 minutes, or about 60 minutes.

When the extraction temperature was explored, higher temperatures typically led to higher extraction than room temperature (e.g., ˜20-25° C.) up to 90° C. as tested, and consistent results were obtained for both soybean meal and okara extractions. Thus, in embodiments, the pre-treatment step is performed at a temperature of at least about 85° C., at least about 86° C., at least about 87° C., at least about 88° C., at least about 89° C. or at least about 90° C. In embodiments, the pre-treatment step is performed at a temperature of about 85° C. to about 100° C., about 85° C. to about 95° C., or about 88° C. to about 92° C., e.g., about 90° C.

When the impact of pH on the soybean protein extraction was tested, it was found that the lowest solubility occurred at acidic pH (˜3.5 to 4), variations from this pH range increased solubility, and mild alkaline conditions led to the highest solubility. In addition, proteins extracted at different pH showed different composition profile as shown by SDS-PAGE. Particularly, pH 2 extraction led to increased total protein but decreased high molecular weight species. The protein extractions of both soybean meal and okara when suspended in either water or a buffer (pH 8 0.03 M Tris-HCl) were explored and it was found that the buffer led to significant increase in protein extraction yield for both biomasses. However, further analyses comparing the buffer with water suspension adjusted to different pHs (by NaOH) before the extraction showed that the increased protein extraction is mainly due to the increased pH, the buffered biomass showed identical extraction efficiency comparing to the water suspension when adjusted to the same pH.

Thus, in embodiments, the pre-treatment step is performed at a mild alkaline pH, for example at a pH about 7 to about 11, about 8 to about 11, about 9 to about 11, or about 10. The aqueous solution may, for example, be water, a saline solution, or a buffer (e.g., Tris buffer).

The concentration of biomass in the aqueous solution for the pre-treatment step may be any concentration suitable to perform the process, for example a concentration of at least about 0.1%, at least about 0.5%, at least about 1%, at least about 2%, at least about 3%, at least about 4%, at least about 5% or at least about 10% (w/v). In embodiments, the concentration of biomass in the aqueous solution is about 0.1% to about 40% or the concentration of biomass in the aqueous solution is about 0.5%, about 1%, about 2%, about 3%, about 4%, about 5% or about 10% to about 40%, about 30% or about 20%.

When the combined impact of both pH and temperature was tested, it was found that increasing the temperature led to increased protein extractability over the full range of tested pH. Protein extraction is quite efficient when reaction condition was set at about pH 8-10 and about 80-90° C. High temperature and high pH condition may also lead to increased carbohydrate solubility, thus decreasing the overall protein content in the soluble fraction. The impact of the combined temperature and pH on total carbohydrate release was analyzed. Between pH 4 to 11, the carbohydrate release was low and not significantly impacted by either pH or temperature. At lower pH, sugar release was increased significantly under all temperatures tested. At pH higher than 11, increased sugar release was measured only at the highest temperature tested. Therefore, a reaction condition of about pH 8-10 and about 80-90° C. is favorable for good quality, good yield of protein extraction from okara without increased carbohydrate release. Thus, in embodiment, the pre-treatment is performed at a temperature of about 88° C. to about 92° C., e.g., about 90° C. and at a pH of about 9 to about 11, e.g., about 10.

To explore how much protein can be released directly from okara without the pre-treatment (pH 10 and 90° C.), okara was directly extracted with water three times and the extracted proteins were combined. Compared to total protein in the starting material, a very small fraction was released (7-8%). In a separate experiment, okara water suspension was pretreated for 1 hr at 90° C., pH 10 (preincubation) and then washed three times. This preincubation step increased the soluble protein recovery. However, only 33% of the total protein in okara was extracted in soluble form. It was thus next assessed whether enzyme treatment could further improve protein recovery.

Enzyme-Assisted Aqueous Extraction Process (EAEP) for Product Extraction from Soybean Biomasses

The impact of cellulase, hemicellulase, cellobiase, amylase, and lipase on the protein extraction efficiency of oilseed biomass was tested using soybean meal (SBM) and okara. Cellulase (Spezyme™ CP), pectinase (Pectinex™ U), and xylanase (HTX4) all led to increased sugar release. A combination of three enzymes resulted in even higher sugar release. Treatment with amylase and lipase did not lead to sugar release. However, treatment with these enzymes did not lead to significant increase in protein release from the biomass.

The impact of protease on total protein recovery was then assessed. A commercially available protease (alkaline protease, CAS Number: 9014-01-1, referred to herein as protease E1) was chosen to test the process. When soybean meal and okara were suspended in the reaction buffer (pH 8, 0.03 M Tris-Cl) and treated with protease E1 (55° C., 1 hr), even a very low dosage (0.025% v/v) of the enzyme could effectively hydrolyze the proteins to small peptide directly from the raw biomass within a short time. Unexpectedly, protease treatment also increase the extracted protein content significantly compared to non-enzyme control incubated under the same conditions. More detailed analyses were carried out with okara and extracted protein was increased 66% compared to non-enzyme control.

Direct addition of enzyme to suspended biomass led to increased protein extraction as described above. It was further explored if a combination of pretreatment before enzyme addition could lead to further improved protein extraction. The pretreatment was carried out by suspending the biomass in the enzyme reaction buffer (pH 8) at the same temperature as the enzyme reaction (55° C.). After solid liquid separation, the released protein in the supernatant is treated as baseline protein release without enzyme treatment. The pellet was further resuspended and treated with enzyme to see if more protein can be released compared to non-enzyme treated sample. When a pretreatment step was introduced followed by enzyme treatment of the pellet; the pretreatment step released a significant amount of protein easily detectable by simply measuring O.D. 280. The following protease treatment further improved protein recovery. Compared to a non-enzyme treated sample, a 89% increase of extracted protein was achieved. However, the recovery of total protein was only about 30% and the majority of proteins remained in the pellet insoluble fraction. When the pretreatment was carried out at higher temperature (90° C.) and pH 8 for 1 hr followed by enzyme treatment, 59% total protein recovery was achieved compared to 38% recovery without enzyme treatment. When the pretreatment was carried out at 90° C. and pH 10 followed by enzyme treatment, up to 85% total protein recovery from okara biomass was achieved. The protein content in the fiber-rich insoluble fraction was significantly reduced. These results indicate that a combination of pretreatment under mild alkaline conditions (pH 10) and high temperature, followed by a protease enzyme treatment step is efficient for protein extraction. Furthermore, such an enzyme assisted aqueous extraction process may have two-fold benefits by not only increasing total protein extraction efficiency but also producing a peptide product that may have better functions, such as increased nutritional digestibility, relative to full length protein/peptide mixtures.

The activities of 10 different proteases (see enzymes E1 to E10 in Table 4 below) towards a standard substrate were characterized, and the soy protein hydrolysis profile was analyzed using both soybean meal and okara with standardized enzyme dosage. The present inventors have found that a similar hydrolysis pattern occurred using different proteases including proteases from Bacillus licheniformis (serine-type protease, subtilisin, Sigma® Cat. No. P5459 and EMD Millipore Cat. No. 126741), Bacillus amyloliquefaciens (serine-type protease, subtilisin, Sigma® Cat. No. P1236), Aspergillus oryzae (endoproteases and exopeptidases, Sigma® Cat. No. P6110), Bacillus sp. (serine-type proteases, subtilisin, Sigma® Cat. Nos. P3111, P5985, P5860), and cysteine proteases (papain, Sigma® Cat. Nos. P3375 and P76220). Most of the hydrolytic processes led to gradual decrease of all sizes of proteins and peptides with some early stage accumulation of short peptides. For all tested enzymes, the majority of the hydrolyzed peptides had a molecular mass of less than 30 kDa.

Even though based on SDS-PAGE analysis, most of these enzymes seemed to release peptides within similar molecular size range, the yield and identity of these peptides may not be the same. For example, the physical and neutraceutical functions of peptides from different protease hydrolysis may not be the same due to different compositions. The skilled person would understand that the protease (or combination thereof) to be used in the process may be selected based on desired criteria, for example better hydrolysis efficiency under certain conditions, desired activity, etc.

The 10 proteases were tested for their ability to generate products with reduced trypsin inhibition activities. Compared to non-enzyme treated material, treatment with the different enzymes resulted in a decrease in trypsin inhibition to varying degrees, the differences likely resulting from the different compositions of the hydrolyzed products obtained.

Thus, in embodiments, the process described herein may be performed using any proteolytic enzyme (protease) or combinations thereof, including endoproteases, exopeptidases, serine-type proteases (e.g., subtilisin), cysteine-type proteases (e.g., papain), threonine-type proteases, aspartic-type proteases, glutamic-type proteases, metalloproteases and asparagine peptide lyases. These proteases may be isolated from any suitable organisms (bacteria, fungus, plants, animals, etc.), or produced recombinantly using commonly used techniques. In an embodiment, the process defined herein comprises the use of one or more serine-type proteases, for example subtitlisins. In another embodiment, the process defined herein comprises the use of one or more cysteine-type proteases, for example papains. In another embodiment, the process defined herein comprises the use of one or more of enzymes E1 to E10 described in Table 4. In an embodiment, the starting biomass is okara and the process defined herein comprises the use of one or more of enzymes E1, E3, E8, and E10 described in Table 4. In an embodiment, the starting biomass is SBM and the process defined herein comprises the use of one or more of enzymes E3, E4 and E9 described in Table 4.

The conditions for the proteolysis step (e.g., temperature, pH, time) may be adapted based the protease(s) used. In an embodiment, the temperature of the proteolysis step is from about 20° C. to about 80° C., about 30° C. to about 70° C., about 40° C. to about 60° C., or about 50° C. to about 60° C. In embodiments, the proteolysis step is carried out at a pH of about 4 to about 12, about 7 to about 11, about 8 to about 11, about 9 to about 11, or about 10. The proteolysis step may be performed in the same aqueous solution as the pre-treatment step, or in a different solution. The pH and temperature may be readjusted between the pretreatment step and proteolysis step.

In embodiments, the proteolysis step is performed for a period of less than about 2 hours, or less than about 90 minutes, or less than about 75 minutes. In other embodiments, the proteolysis step is performed for a period of at least 15, at least 20, at least 25, at least 30, at least 35, at least 40 or at least 45 minutes. In further embodiments, the proteolysis step is performed for a period of about 15 minutes to about 90 minutes, about 30 minutes to about 75 minutes, about 45 minutes to about 75 minutes, about 50 minutes to about 70 minutes, or about 60 minutes.

In an embodiment, the process defined herein further comprises a step of inactivating the proteolytic enzyme after the proteolysis step. Methods to inactivate proteases are well known in the art and include, for example, chemical inactivation (e.g., using a protease inhibitor), pH inactivation (e.g., by adding an acid or a base so that the pH of the mixture/slurry is incompatible with proteolytic activity) or heat inactivation. In an embodiment, the step of inactivating the proteolytic enzyme comprises heat inactivation, for example by heating the slurry to a temperature of at least 70 or 80° C. for at least 5 or 10 minutes. In an embodiment, the heat inactivation comprises heating the slurry to a temperature of 80 to about 100° C. (e.g., 80, 85, 90 or 95° C.) for a period of about 5 to about 30 minutes, preferably about 10-20 minutes or about 15 minutes.

### Reduction of the Phytate (Phytic Acid) Content in the Products

It may be desirable to reduce phytate content in the products obtained using the process described herein. Notably, phytate is often referred as an 0 because of its interference with the absorption of certain nutrients such as minerals (calcium, magnesium, iron, copper, and zinc). To achieve this objective, selected divalent cations (CaCl₂, MgCl₂, MnCl₂, and FeCl₂) were tested to reduce (by precipitation) the concentration of the anti-nutritive phytate in the peptide product. Under the production conditions tested (pH 10), MnCl₂ seemed most effective at inducing phytate precipitation, particularly at lower concentration. At 1.5× equivalents (one equivalent, 1×, is defined as six molecules of divalent cation, such as calcium, per molecule of phytate) and higher concentrations, CaCl₂ and FeCl₂ also performed very well. CaCl₂, in optimized conditions and when used at higher concentrations, was able to result in a 95% reduction of the phytate concentration in the final product when tested in bench-scale experiments.

Accordingly, in an embodiment, the process defined herein further comprises a step of reducing the phytate content. Methods for reducing phytate content in compositions are well known in the art, and include, for example, treatment with a phytate-decomposing enzyme (e.g., a phytase) or divalent cations. Phytases may be from any sources/origins, e.g., fungi, bacteria, yeast, or plants. In a further embodiment, the process comprises treating the proteolytic enzyme-treated slurry of step b) with a solution comprising one or more divalent cations, for example a solution comprising one or more of CaCl₂, MgCl₂, MnCl₂, and FeCl₂. In a further embodiment, the solution comprises CaCl₂. In embodiments, the amount of divalent cation in the slurry is about 0.5× to about 50× equivalents, or about 1× to about 40× equivalent, or about 1.5× to about 25× equivalents.

### Final Process Developed for Product Recovery and Quality

With the identification of: a two-step protease process; a proper enzyme candidate for proteolysis and reduced trypsin inhibition activity; and the condition to add divalent cation for phytate precipitation; a process was finalized for optimum product recovery and quality. According to an embodiment described herein, the optimal parameters identified are: pretreatment at about 90° C., pH 10 for about 1 hr, followed by treatment with enzymes of selected dosage for about 1 hr and CaCl₂ was added at identified dosage. The supernatant (liquid fraction) is then separated from the solid fraction (e.g., using centrifugation, filtration, or any other suitable method for separating liquid and solid fractions), and may be concentrated and dried to obtain the protein/peptide-rich soluble product. The solid fraction enriched in fibers may be dried for use as a fiber product for food or feed.

The present invention thus relates to a process for producing a protein- and/or peptide-enriched fraction and a dietary fiber-enriched fraction from a biomass comprising:

a) obtaining the biomass in either dry or wet form;
b) optionally grinding the biomass;
c) solubilizing and extracting the biomass or the ground biomass with an aqueous solution with pH adjusted to alkaline conditions and temperature adjusted to 90° C. or above;
d) readjusting the temperature and pH of the aqueous slurry and treating it with a proteolytic enzyme;
e) optionally decreasing the phytate content, for example by adding a divalent cation solution (e.g., CaCl₂)) to the slurry to precipitate the phytate content;
f) optionally inactivating the proteolytic enzyme;
g) separating the liquid and solid fractions;
h) optionally concentrating the liquid fraction to obtain a liquid concentrate;
i) optionally drying the liquid concentrate to obtain a soluble protein- and/peptide-rich product; and
j) optionally drying the solid fraction to obtain a water-insoluble fiber-rich product.

In embodiments, step e) may be carried out after step g), followed by another round of solid/liquid separation to eliminate the precipitated phytate content. The liquid fraction may be further concentrated and dried as final product.

In embodiments, prior to step h), the liquid fraction may be subjected to one or more purification step(s), for example purification based on molecular mass or size differences using membrane filtration systems based on features of the targeted product.

In an embodiment, the process defined herein does not comprise the use of an organic solvent.

### Product Features

Table 1 shows a composition comparison between Arcon® F (from Archer Daniels Midland, ADM) and two peptide products obtained by the process described herein. Amino acid profile analyses of protein/peptide samples extracted from okara showed similar ratios of both essential and non-essential amino acids when compared to a commercial soy protein concentrate (SPC) Arcon® F from ADM, suggesting equal nutritional value may be expected if other features are the same. However, solubility analyses showed that the extracted protein/peptide product obtained by the process described herein exhibited consistently high solubility (>80%) over a wide range of pH (3 to 11), whereas the commercial SPC Arcon® F showed only ˜10% solubility between pH 3 to 9 and raised to 25% only at pH 11. Compared to Arcon® F, the okara-derived peptide product obtained by the process described herein contained a lower amount of protein, mainly due to the lower protein content in the starting material (okara, 25% vs soybean meal, usually >50%) and the extra lipid in the okara and peptide product. However, lower concentrations of antinutritional factors were detected in the okara extract obtained by the process described herein relative to Arcon® F. The enzymatic process also led to protein/peptide products mostly smaller than 20 kDa with a >20% degree of hydrolysis. The process also resulted in lower trypsin inhibition activity and phytic acid content. Therefore, the extracted protein/peptide products obtained by the process described herein may be used for wider range of applications including food, feed, drink, cosmetics and with good functionality and nutritional value.

TABLE 1
Composition comparison of okara products obtained by
the process described herein with a commercial soy
protein concentrate, Arcon ® F

| | | | | Trypsin | |
|---|---|---|---|---|---|
| | Protein | | | inhibitor | Phytate |
| | content | Carbohydrate | Lipid | activity | content |
| | (%) | (%) | (%) | (TUI/mg) | (mg/g) |
| Arcon ® F | 65.57 | 24 | ND | 4.53 | 36.8 |
| Peptide | 45.82 | 20.64 | 11.40 | 2.58 | 22.3 |
| extract 1 | | | | | |
| Peptide | 51.11 | 22.08 | 18.80 | 3.19 | 28.3 |
| extract 2 | | | | | |
| Okara | 25 | 64 | 8 | 4.8 | 18.4 |
| Fiber | 10 | 76 | 7.5 | 2.96 | 13.5 |
| extract 1 | | | | | |
| Fiber | 7 | 77 | 8.6 | 3.79 | 13.3 |
| extract 2 | | | | | |

Thus, in another aspect, the present invention relates to a protein and/or peptide-rich dry biomass extract, preferably a soy biomass extract, comprising one of more of the features described herein. In an embodiment, the protein and/or peptide-rich dry biomass extract comprises at least 2, 3, 4 or 5 of the features described herein. In a further embodiment, the extract comprises at least 1, 2, 3 or all of the following features:
a) a water solubility of more than 80% over a pH of about 3 to about 11;
b) a protein and/or peptide content of about 40% or more;
c) at least 75% of the proteins and/or peptides in the extract have a molecular weight of less than 20 kDa;
d) a reduced trypsin inhibition activity and phytate content relative to a commercial soy protein concentrate (SPC).

In a further embodiment, at least 80%, at least 85%, or at least 90% of the proteins and/or peptides in the extract have a molecular weight of about 20 kDa.

In an embodiment, the extract has a trypsin inhibition activity that is less than about 3, 2.5, or 2 TUI/mg as measured using the methods described in the Examples below.

In an embodiment, the extract has a phytate content that is less than about 25 or 20 mg/g as measured using the methods described in the Examples below.

In an embodiment, the protein and/or peptide-rich dry biomass extract is obtained by the process described herein.

In another aspect, the present invention provides a fiber-rich dry biomass extract, preferably a soy biomass extract, comprising one of more of the features described herein. In an embodiment, the fiber-rich dry biomass extract is obtained by the process described herein.

In embodiments, the extracts described herein may be incorporated into various foods such as beverages (e.g., soft drinks); milk products; sauces; confectionery such as baked confectionery, nutrient bars, cereals, candies, gums, jellies and the like; tablets; breads; cooked rice; vegetarian foods (hamburgers, sausages, granola products, pâtés) and the like. In an embodiment, an extract described herein is incorporated into an animal feed (livestock, pets).

In embodiments, the extracts described herein may be incorporated into cosmetic products/compositions. Such cosmetic products/compositions may be for example in the form of a cream, emulsion, foam, gel, lotion, milk, mousse, ointment, paste, powder, spray, or suspension. The cosmetic product/composition optionally comprises at least one cosmetically acceptable auxiliary agent. Cosmetically acceptable auxiliary agents include, but are not limited to, carriers, excipients, emulsifiers, surfactants, preservatives, fragrances, perfume oils, thickeners, polymers, gel formers, dyes, absorption pigments, photoprotective agents, consistency regulators, antioxidants, antifoams, antistats, resins, solvents, solubility promoters, neutralizing agents, stabilizers, sterilizing agents, propellants, drying agents, opacifiers, cosmetically active ingredients, hair polymers, hair and skin conditioners, graft polymers, water-soluble or dispersible silicone-containing polymers, bleaches, care agents, colorants, tinting agents, tanning agents, humectants, refatting agents, collagen, protein hydrolyzates, lipids, emollients and softeners, tinting agents, tanning agents, bleaches, keratin-hardening substances, antimicrobial active ingredients, photofilter active ingredients, repellant active ingredients, hyperemic substances, keratolytic and keratoplastic substances, antidandruff active ingredients, antiphlogistics, keratinizing substances, active ingredients which act as antioxidants and/or as free-radical scavengers, skin moisturizing or humectants substances, refatting active ingredients, deodorizing active ingredients, sebostatic active ingredients, plant extracts, antierythematous or antiallergic active ingredients, and mixtures thereof.

The present invention also relates to a beverage, cosmetic, food, or feed product comprising the protein and/or peptide-rich dry biomass extract or the fiber-rich dry biomass extract described herein.

The present invention also relates to a method of preparing a beverage, cosmetic, food, or feed product comprising (i) performing the process described herein to obtain a protein and/or peptide-rich dry product; and incorporating said protein and/or peptide-rich dry product to a beverage, cosmetic, food, or feed composition.

The present invention also relates to a method of preparing a beverage, cosmetic, food, or feed product comprising (i) performing the process described herein to obtain a fiber-rich dry product; and incorporating said fiber-rich dry product to a beverage, cosmetic, food, or feed composition.

### EXAMPLES

In order that the invention may be more clearly understood, embodiments thereof will now be described in detail by way of non-limiting examples, with reference to the accompanying drawings.

### Example 1: Dosage Analysis of Protease E1 on Okara and Soybean Meal Hydrolysis

To analyze if protease can efficiently hydrolyze soybean protein directly from raw biomass without first purifying the protein, freeze-dried defatted soybean meal samples were suspended in 0.03M Tris-HCl (pH 8.0) buffer at a 2.8% solid:liquid ratio (W/V) and incubated with the addition of enzyme for 1 hour at 55° C. One of the popular commercially available proteases (Sigma P5459; defined herein as protease E1) was used to test the dosage effect on soy protein hydrolysis. For blank, reactions were carried out in separate tubes with no enzyme addition. Enzyme dosages tested were 0.0025, 0.005, 0.01, 0.02, 0.04, 0.08% (v/v). After 1 hour, the reactions were stopped by incubating the reaction tubes at 95° C. for 15 minutes. Reaction tubes were centrifuged at 20,000×g for 20 minutes to separate the liquid and solid fractions. The supernatants were analyzed on SDS-PAGE gel. Equal volume (15 μl) of liquid from each reaction was loaded on a 12% acrylamide gel and the SDS-PAGE gel was run at 130 volts for 1 hour and then stained with Coomassie blue. The results are presented in FIG. 2. Compared to no enzyme control, the very low dosage of enzyme was enough to hydrolyze the higher molecular weight proteins to mostly lower than 40 kDa. Increased dosage led to further decreased density of the higher molecular weight proteins as well as the lower molecular weight ones around 30-40 kDa, suggesting that more proteins were hydrolyzed to smaller peptide lower than 30 kDa. At the dosage of 0.04%, the majority of proteins was hydrolyzed to short peptide except a very weak fraction of peptides around 30-40 kDa. With a further increase of the dosage to 0.08%, the peptides around 30 kDa became hardly visible. These results suggest that soybean proteins were highly hydrolyzed to short peptides or amino acids within 1 hour with a small dosage of protease E1.

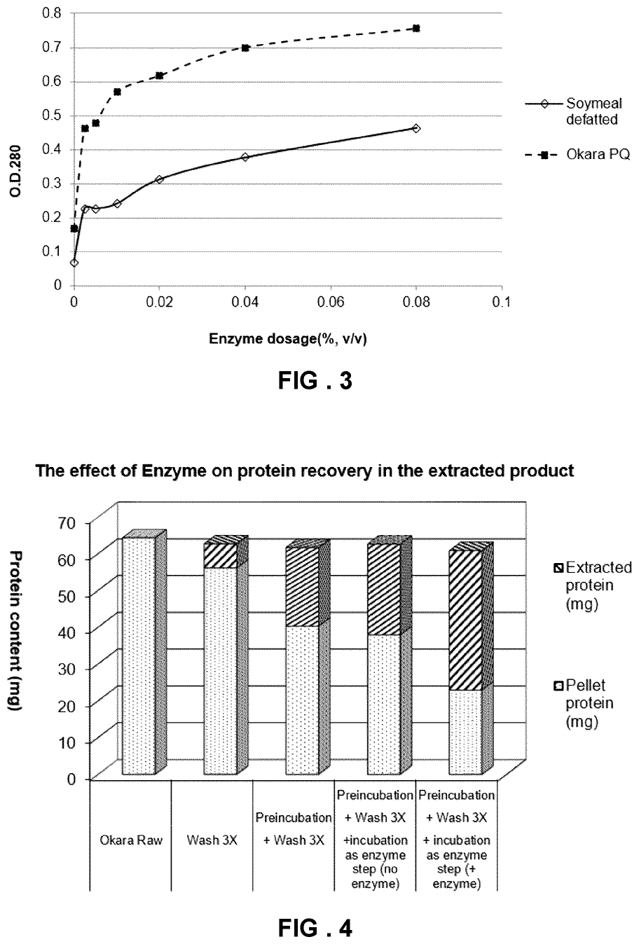

To analyze the protease E1 dosage effects on soybean and okara protein extraction, both soybean meal and okara samples were freeze-dried and suspended in 0.03M Tris-HCl (pH8.0) buffer at 2.8% solid:liquid ratio (W/V). Reaction incubation, protease E1 dosage and solid liquid separation were the same as previously described. Supernatants were tested for released protein contents by measuring absorption at O.D. 280 nm. The O.D. 280 values were plotted against the enzyme dosage (FIG. 3). For both okara and soybean meal, the enzyme affects protein release at very low dosage. Increased dosage led to increased protein release which plateaued at the dosage of ˜0.05%. This significant increase in protein release of either soybean meal or okara due to protease hydrolysis was unexpected. Further detailed characterization of this impact is reported in following examples.

### Example 2: The Impact of Protease on the Protein Extraction Yield from Okara

To further determine the effects of protease treatment on protein extraction from okara, freeze-dried okara was suspended in 0.03M Tris-HCl (pH 8.0) buffer a 2.8% solid:liquid ratio and incubated for 1 hour at 55° C. Solid and liquid were separated by centrifugation at 20,000 g for 10 minutes on bench top centrifuge, and the supernatant was kept. Protease E1 at 0.01% v/v ratio was added and the reaction was incubated at 55° C. for 1 hour. Afterwards, the reaction was stopped by incubation at 95° C. for 15 minutes. For the no enzyme control, a separate reaction without enzyme addition was carried out in parallel. After the 15-minute step at 95° C., the supernatant was collected after centrifugation and the pellet was extracted once more with the same buffer for 1 hour at 55° C. After the liquid and solid separation, the protein content of all the liquid separately kept and freeze-dried was analyzed using the Bradford protein assay (BPA) method with the Coomassie Plus Assay Kit (Thermo Scientific) according to the manufacturer's protocol. Alternatively, okara samples were suspended in the Tris buffer and directly treated with protease followed by a washing step as described previously. A parallel non-enzyme control experiment was carried out in a separate reaction. The protein released in the supernatants from each step was analyzed using the same kit. The results were summarized in table 2.

When the protease was directly added to okara suspension, the amount of protein extracted in the enzyme step was twice that extracted in the non-enzyme control. When including the post-treatment step, total extracted protein was increased by 66% relative to the non-enzyme control. When a pre-treatment step was introduced, the enzyme treatment step alone led to 4.5-times more protein extraction relative to non-enzyme control. When the total proteins of all three steps were added up, a 89% increase of total extracted protein was achieved.

TABLE 2
Soluble protein contents in the supernatants of different extraction steps

| | Extraction steps | | | | | | |
|---|---|---|---|---|---|---|---|
| | Buffer | | Buffer | | Enzyme | Buffer | |
| Protein | extraction | Enzyme | extraction | | extraction | extraction | |
| Content | (pre | extraction | (post | | (direct | (post | |
| (O.D280) | treatment) | (treatment) | treatment) | Total | hydrolysis) | treatment) | Total |
| Control | 0.99 | 0.24 | 0.29 | 1.52 | 0.84 | 0.51 | 1.35 |
| Enzyme | 1.29 | 1.08 | 0.51 | 2.88 | 1.75 | 0.49 | 2.24 |
| E/C | | | | 1.89 | | | 1.66 |
| ratio | | | | | | | |

### Example 3: Impact of Protease on Protein Contents in Soluble Form and Fiber Pellet of Okara

Protein contents for solid biomass, okara, fiber pellet, and extracted soluble fractions were all determined by Kjeldahl method (AOAC Official Methods 2001.11; J AOAC Int. 1999, 82:1389-1398) with the Gerhardt Kjeldatherm Digester, Gerhardt Vapodest™ 20s Distiller, and titrated with the SI Analytics Titolinen™ 6000.

To determine the water released proteins, freeze dried okara (250 mg) was suspended in water with a 2.8% solid:liquid ratio at room temperature. Solid and liquid were separated by centrifugation at 2800 g for 15 minutes on an Allegra™ X-12R (Beckman Coulter) centrifuge and the supernatant was saved. The pellet was resuspended and the process was repeated two more times. The supernatants from the three repeats were combined. Both the pooled supernatant and pellet were freeze dried and protein contents were determined by Kjeldahl method.

For the okara pre-incubation and wash, freeze dried okara was suspended like last step, incubated at pH 8.0 (adjusted with 4N NaOH) and 90° C. for 1 hour. Supernatants of the incubation and three washes were combined. Protein contents of supernatants and pellet were determined as described in last step.

For the enzyme blank, okara was washed three times, incubated at 90° C. in pH 8.0 for 1 hour. The liquid was separated from solid and the pellet was washed three times as described above. Pellet was then resuspended in water to the original volume, adjusted pH to 8.0 and incubated at 55° for 1 hour without enzyme. Liquid was separated from solid as described above and pellet was washed three times. All the liquid supernatants were combined. Both the pooled liquid and the washed pellet were freeze dried and protein contents were determined by Kjeldahl method. For enzyme assisted extraction, all operations were the same as the enzyme blank except with the addition of 0.005% (V/V) protease E1 at the 55° for 1 hour.

The protein recovery in supernatants and remaining protein contents in pellets after different operations are shown in Table 3 and FIG. 4. Three washes at room temperature led to 10% protein release; high temperature, pH 8 pre-incubation followed by three washes led to 33% protein recovery; when another step (55° for 1 hour) non-enzyme treatment was added and followed by three washes, 38% protein recovery was achieved; adding the enzyme during the 1-hour step at 55° led to 59% protein recovery in the supernatants. Correspondingly, the protein content left in the pellet decreased from 87% to 36%.

TABLE 3
Protein contents in supernatants and pellets of following different extraction steps

| | | | | | | Pre- |
|---|---|---|---|---|---|---|
| | | | | | Pre- | incubation, |
| | | | | | incubation, | 3 washes, |
| | | | | | 3 washes, | 55° for |
| | | | Room | Pre- | 55° for | 1 hour |
| | | Raw | temperature | incubation, | 1 hour, | with enzyme, |
| Operation steps | | okara | 3 washes | 3 washes | 3 washes | 3 washes |
| Protein | Supernatant | | 6.58 | 21.36 | 24.66 | 37.88 |
| content | Recovery | | 10 | 33 | 38 | 59 |
| (mg) | protein (%) | | | | | |
| | Raw okara/ | 64.28 | 56.07 | 40.26 | 37.91 | 22.91 |
| | pellet | | | | | |
| | Remaining | 100 | 87 | 63 | 59 | 36 |
| | protein (%) | | | | | |

### Example 4: Effect of PH and Temperature on Protein Extraction

Freeze dried okara was suspended in water at 2.5% (W/V) ratio, pH was adjusted with 4N HCl (pH 1.547) or 4N NaOH (pH 7412). Okara suspensions at different pHs were incubated at different temperatures for 1 hour. Solid and liquid separation was carried out by centrifugation at 2800 g for 10 minutes. The protein contents in the supernatants were analyzed with the Protein DC Kit (BioRad®) following the manufacturer's protocol.

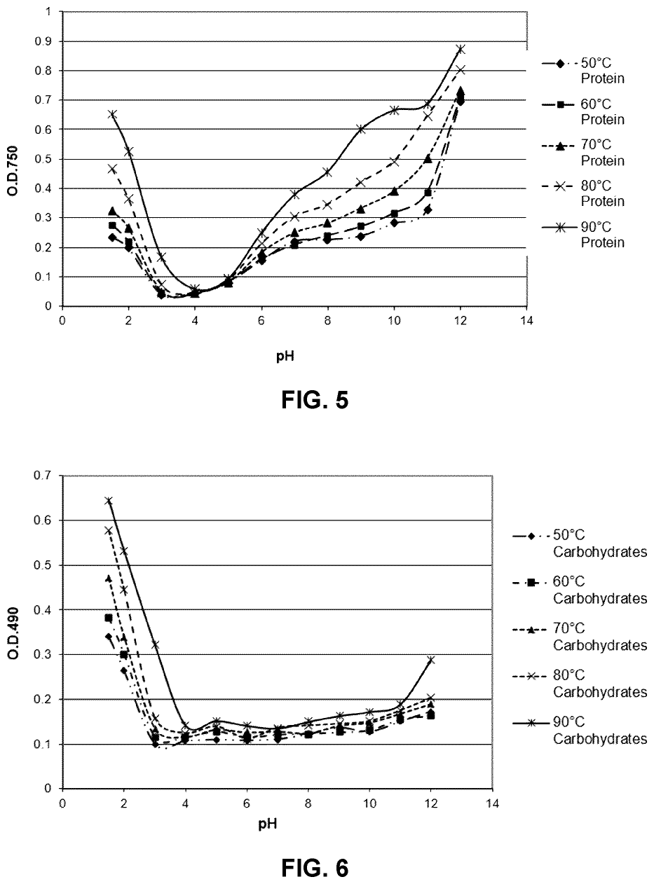

The combined impacts of pH and temperature are shown in the graph depicted at FIG. 5. Increased temperature led to increased protein extractability over the full range of tested pH. Protein solubility was the lowest between pH 3 to 5 and increased in both directions when pH was adjusted either higher or lower. At 90° C., pH 1 and pH 10 led to similarly high protein release. At pH 10 and 90° C., protein recovery is high and these conditions would be compatible with practical production process.

### Example 5: Effect of PH and Temperature on Carbohydrate Extraction

Total carbohydrate was analyzed by the Phenol/Sulfuric acid method (Nielsen, 2003, Food Analysis Laboratory Manual, Chapter 6; DuBois et al., 1956, Anal. Chem., 28:350-356; Mecozzi, 2005, Chemometrics and Intelligent Laboratory Systems, 79:84-90) with modifications. Okara samples were suspended and incubated at different temperatures and pHs and extracted for 1 hour as described above. Supernatants (10 μL) from different extractions were placed in a 15 mL Falcon™ tube. After addition of water and 80% phenol, stock H₂SO₄ was added directly to the tube. Samples were vortexed and allowed to stand for 10 minutes at room temperature and then cooled in a 25° C. water bath for 10 minutes, followed by O.D. 490 reading with a UV spectrometer. The O.D. values versus the pH were plotted as shown in FIG. 6.

One major target for the process development was to increase the protein recovery and protein content in the extracted product. The protein content is also affected by the released carbohydrate in the extracted products. The combined impacts of both pH and temperature on sugar release were tested. Between pH 4 to 11, the carbohydrate release was low and not significantly impacted by either pH or temperature. At lower pH, sugar release was increased significantly under all temperatures tested. At pH higher than 11, sugar release increase was measured only at the highest temperature tested. Therefore, an acidic condition would not be favored even if protein release is high. At higher pH and temperature, the carbohydrate release was not increased while protein release was increased, and thus increased protein recovery and higher protein content in the extracted product is possible.

### Example 6: Effects of Enzyme Treatment on Trypsin Inhibitor Activity of Soybean Samples

Ten commercially available proteases listed in Table 4 (E1 to E10) were tested according to the established EAEP process with okara and defatted soybean meal. Relative activities of proteases were tested based on the Universal Protease Activity Assay procedure (Sigma®) with the non-specific substrate casein (Sigma®). The pretreated okara and soybean meal (SBM) was hydrolyzed with a standardized amount of each enzyme.

Trypsin inhibitor activity assay was performed following published methods (Kakade, et al., 1969, Cereal Chem 46:518-526; Kakade, et al., 1974, Cereal Chem 51:376-381) with minor modifications. Dried samples (0.5 g) were ground to pass through 60 mesh sieve and extracted with 25 ml 0.01N NaOH for 3 hours while shaken at 150 rpm at room temperature (pH of the suspension ˜9.5 to 9.8). The suspension was diluted so that 40-60% of trypsin inhibition was achieved. After being mixed with trypsin solution, the reaction was incubated in 37° C. water bath for 10 minutes followed by addition of benzoyl-DL-arginine-p-nitroanalide hydrochloride (BAPA) solution and incubation for another 10 minutes. After the reaction was stopped with acetic acid, O.D. 410 was measured against a reagent blank and sample blanks.

Trypsin Unit (TU) is arbitrarily defined as an increase of 0.01 absorbance units at 410 nm per 10 ml of the reaction mixture under the conditions used. Trypsin Unit Inhibited (TUI) is the difference of Trypsin Units assayed with and without soy samples.

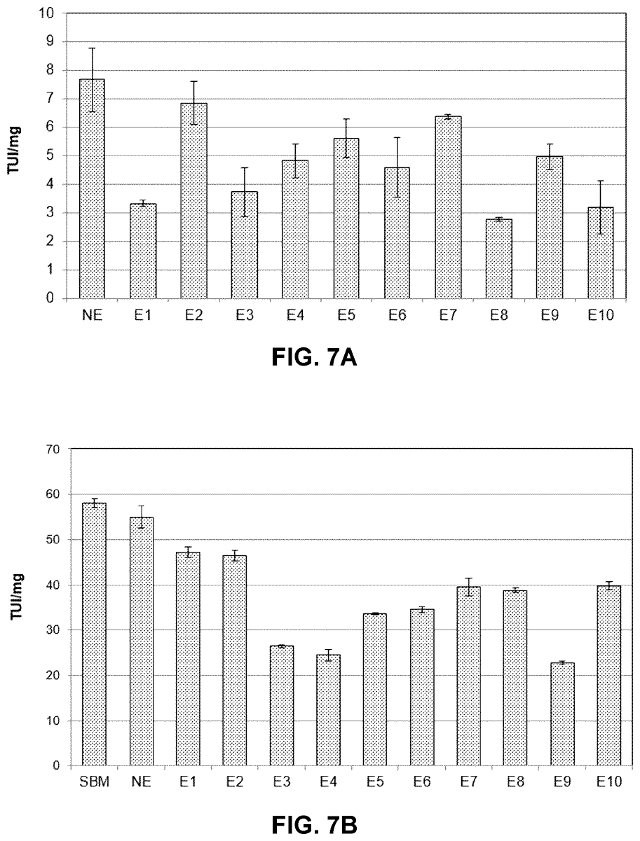

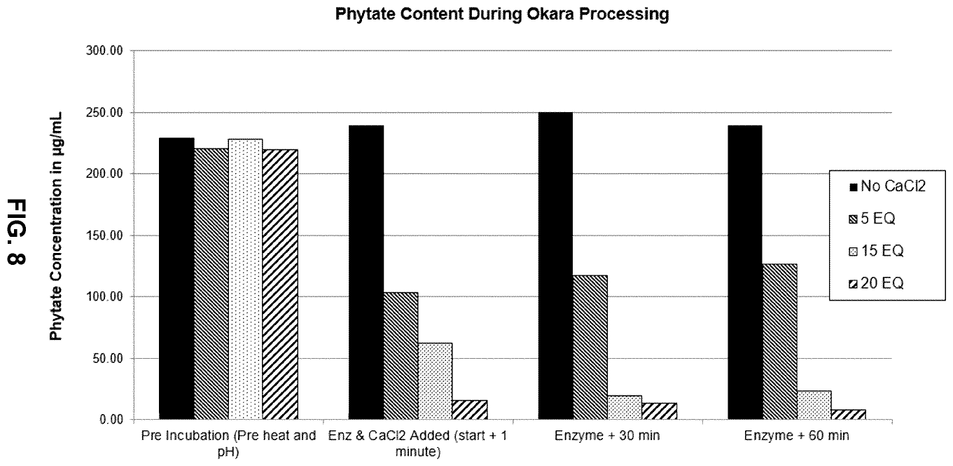

Compared to the control samples, treatment with all the enzymes resulted in varying degrees of decrease in trypsin inhibition activity as shown in FIGS. 7A and 7B. Enzymes 1, 3, 8, and 10 demonstrated the most significant effect on okara, whereas enzymes 3, 4, and 9 were the most effective on soybean meal.

TABLE 4
List of enzymes used in the screening process

| Enzyme | E1 | E2 | E3 | E4 | E5 |
|---|---|---|---|---|---|
| Synonyms | Alcalase, | Flavourzyme | Savinase | Everlase | Papainase |
| | subtilisin | | | | |
| Supplier | Sigma ® | Sigma ® | Sigma ® | Sigma ® | Sigma ® |
| | 5459 | P6110 | P3111 | P5985 | P3375 |
| Enzyme | E6 | E7 | E8 | E9 | E10 |
| Synonyms | Esperase | Neutrase | Alcalase | Papain | Alcalase |
| Supplier | Sigma ® | Sigma ® | Calbiochem ® | Fluka ® | Novozymes ® |
| | P5860 | P1236 | | 76220 | PLN05378 |

### Example 7: Phytate Content of Protein Extracted from Okara

Phytate content assay was performed following published methods (Dragic̊ević et al., 2011, Acta periodica technologica 42:11-21; Gao et al., 2007, Crop Science 47: 1797-1803) with minor modifications.

Dried samples of okara (0.5 g) were passed through a 60 mesh sieve and incubated with HCl and TCA at room temperature for 2 hours while shaking at 250 rpm. After centrifugation at 10,000 g for 20 minutes at 10° C., the supernatant was filtered with 0.22 μM syringe filter units and then diluted 25 times with deionized H₂O.

Colorimetric determination of phytate content was carried out by adding Wade reagent (0.03% FeCl₃6H₂O and 0.3% sulphosalicylic acid) into the reaction tubes. After centrifugation, absorbance was measured at 500 nm.

Calculation: The decreased values in O.D. 500 reflect phytate content in the samples, which was obtained by subtracting the sample absorbance from reagent blank absorbance. The phytate amount was calculated with a sodium phytate standard curve.

The effect of CaCl₂) addition on phytate concentration in the extracted peptide product from okara was examined. In separate experiments, different amount of CaCl₂) was added during the extraction process and samples were taken at different time points. As shown in FIG. 8, with the increase of equivalents of CaCl₂) in the hydrolytic process, the amount of phytate in the extracted soluble product decreased in a dose-dependent manner. At 15 equivalents and higher, the phytate content dropped to minimum at 30 min after CaCl₂) addition. At the end of the process, the control slurry of okara (with no CaCl₂) added) had ˜240 μg/mL of phytate, whereas the addition of CaCl₂) at higher concentration led to up to 95% phytate reduction in the final product as shown in FIG. 8.

### Example 8: Degree of Hydrolysis (% DH) of Okara Peptide

Okara biomass was suspended in water at 10% solid:liquid ratio, pH was adjusted to 10 with 4N NaOH and extracted at 90° C. for 1 hr, The temperature was then adjusted to 55° C. and pH was readjusted to 8 using 4N HCl. Protease 1 was added at a dosage of 0.005% and hydrolytic samples were taken at different time points. Experiments were repeated and control experiments without enzyme were run in parallel as comparison. The hydrolytic process was monitored by measuring degree of hydrolysis (% DH).

The % DH was performed with o-phthaldialdehyde (OPA) following published procedures (Nielsen et al., 2001, J Food Sci. 66: 642-646; Vigo et al., 1992, Food Chem. 44:363-365) with minor modifications. Samples were diluted to contain between 1-10 mg protein per mL, dilution factors were recorded. After all reaction reagents were added, the mixture was allowed to stand for exactly 2 minutes before measuring A₃₄₀.

DH was calculated as: % DH=h/hₜₒₜ*100;
h=(serine-NH₂-β)/α;
Parameters for soybean proteins: β=0.342; α=0.970; hₜₒₜ=7.8.
Equivalent serine-NH₂ from OD readings was obtained as follows:

$$serine - NH2 = \frac{( {A}_{340 , sample} - {A}_{340 , blank} )}{( {A}_{340 , standard} - {A}_{340 , blank} )} * 0.9516 \frac{meqv serine}{L} * \frac{{L}_{volume}}{{g}_{sample}} * \% protein$$

Reaction volume (L), sample weight (g) and protein concentration were obtained based on reaction conditions. % protein of sample is input as a percentage, not a fraction.

The results presented in table 5 show an increased degradation of hydrolysis within 5 min of reaction and the DH keep increasing towards the last time point. At 60 min, a % DH of 24 to 27% was reached while the control samples stayed constant between 7 and 10%.

TABLE 5
DH (%) of okara peptides over the time course of 90 min

| Time (minutes) | Control 1 | Control 2 | Exp. 1 | Exp. 2 |
|---|---|---|---|---|
| 0 | 9.1 | 6.8 | 7.1 | 7.2 |
| 5 | 10.1 | 6.8 | 12.9 | 12.9 |
| 15 | 8.8 | 6.7 | 15.9 | 17.69 |
| 30 | 9.1 | 6.8 | 19.5 | 22.3 |
| 45 | 9.3 | 6.7 | 22.5 | 25.3 |
| 60 | 8.9 | 7.0 | 23.6 | 26.6 |
| 90 | 9.7 | 6.9 | 26.9 | 31.0 |

### Example 9: Comparison of Product Solubility from Okara with the Commercial Product Arcon® F

Protein solubility was measured by using the methods of Lee and Morr (Lee et al., 2003, JAOCS 80, 85-90; Morr et al., 1985, J. Food Sci. 50:1715-1718) with minor modifications. One batch of the okara peptide product prepared by protease E1 and the commercial product Arcon® F (ADM) were suspended in 0.1 M NaCl solution at 2% (W/V) concentration. After adjusting the pH with 1 N NaOH or 1 N HCl solution, the suspensions were thoroughly mixed with an air shaker at room temperature, 100 rpm, for 30 min. The suspensions were then centrifuged at 20,000 g for 15 min. The protein contents of the supernatants and the original solid powders were measured using the Kjeldahl method and the conversion factor of 6.25. Protein solubility was calculated as a percentage of proteins in the supernatant over the total proteins in the original samples.

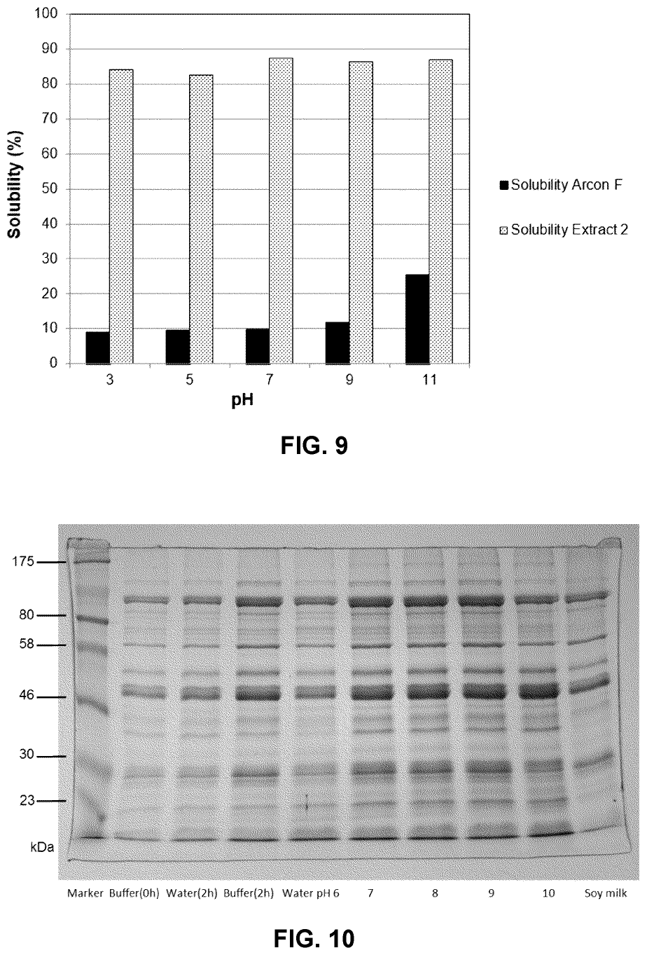

Compared to the commercial soy protein concentrate Arcon® F that showed only ˜10% solubility between pH 3 to 9 and a 25% solubility at pH 11, the extracted protein/peptide product obtained by the process described herein exhibited consistently high solubility (>80%) over the whole tested range of pH (3 to 11) (FIG. 9).

### Example 10: Effects of Enzyme and CaCl₂) Treatment on the Protein and Anti-Nutritional Factors Concentrations in the Okara Soluble Extracts

The established procedure including a pre-treatment step, followed by an enzyme treatment was performed with the addition of CaCl₂) at 5 equivalents amount during the enzyme step to reduce the concentration of the anti-nutrient phytate. The extraction was performed three times at the 1 L scale. Control extractions with no enzyme and/or no CaCl₂) were also performed three times. A sample of the final extract was lyophilized and analyzed for yield and anti-nutritional factors (trypsin inhibition activity and phytic acid). The extraction procedure with enzyme and CaCl₂) led to a protein recovery of 53% which is slightly less than the extraction without CaCl₂) (60%), suggesting that CaCl₂) may also reduce the solubility or precipitate some soluble proteins when added to the biomass suspension during enzyme hydrolysis. However, the enzymatic process with or without CaCl₂) generated protein yields greater than the extraction without enzyme (47%). In addition, the protein contents in the hydrolysates were also increased. In terms of reproducibility, all three extraction procedures generated protein yields that varied by no more than 8.5% (standard deviation). In the extracted products, the anti-nutritional factors were reduced when CaCl₂) and protease were used in the procedure. The addition of CaCl₂) resulted in a 40% reduction of phytic acid and the addition of enzyme resulted in a 60% reduction of trypsin inhibition activity as shown in table 6. Depending on the need of the final product, phytate content can be further reduced by increasing CaCl₂) concentration when needed.

TABLE 6
Effect of enzyme and CaCl₂ treatment on protein and anti-nutritional
factors concentration in the extracted peptide product

| | | | | Trypsin |
|---|---|---|---|---|
| | Protein | Protein | Phytate | Inhibition |
| | Recovery % | content % | (mg/g) | (TUI/mg) |
| No enzyme | 46.76 ± 3.88 | 36.17 ± 0.98 | 25.15 ± 3.53 | 4.77 ± 0.73 |
| No CaCl₂ | | | | |
| Enzyme | 60.14 ± 3.13 | 42.02 ± 1.95 | 26.49 ± 2.10 | 1.72 ± 0.43 |
| No CaCl₂ | | | | |
| Enzyme | 53.19 ± 2.07 | 44.30 ± 0.5 | 15.33 ± 0.99 | 2.00 ± 0.06 |
| CaCl₂ | | | | |

### Example 11: Comparison of Proteins Extracted from Okara and Whole Soybean

Okara proteins were extracted by suspending dried okara in pH 8 Tris-Cl buffer or in water adjusted to different pH (pH 6, 7, 8, 9 and 10) as described above. Soymilk was prepared from the same kind of soybean as the okara by first soaking the dry soybean in water for 2 hrs at room temperature, followed by grinding for 10 min and then boiling of the ground suspension for 30 minute. Soymilk was obtained by filtering through 3 layers of cheese cloth. The extracted samples were compared by running SDS-PAGE gel followed by Coomassie blue staining. The peptide profiles of proteins extracted from okara showed very similar patterns including both the storage soybean 11S/7S proteins and other minor components (FIG. 10). This suggests that there is no significant difference in protein/peptide compositions between okara extracted protein and the whole soybean extracted protein.

Further, the amino acid profile of four different batches of okara peptide extract was compared with that of the commercial soy protein concentrate Arcon® F. Both Arcon® F and the okara peptide extracts were hydrolyzed by HCl following conventional method. Amino acid profile analysis was performed using the Agilent ZORBAX™ Eclipse Plus C18 AA method with the Zorbax™ Extend C18 column (Agilent p/n 763954-302) according to the manufacturer's instructions (Agilent Application Note 5990-454, for foods and pharmaceuticals). Amino acid internal standards preparation, mobile phase and gradient were selected according to the manufacturer's instructions with a flow rate of 0.42 mL/min. Detection with the diode array detector (DAD) and quantitation (internal standard and calibration solutions) were also performed following the manufacturer's instructions. For each sample, assays were repeated twice and averages of the repeats were reported in table 7.

TABLE 7
Amino acid profile analysis of four different batches
of okara peptide extracts (R1P-R4P) and of the
commercial soy protein concentrate Arcon ® F

| AAs (g/100 g protein) | SPC (Arcon F) | R1P | R2P | R3P | R4P |
|---|---|---|---|---|---|
| Threonine | 3.37 | 3.62 | 3.35 | 3.30 | 2.82 |
| Valine | 3.36 | 3.88 | 3.39 | 3.65 | 3.78 |
| Isoleucine | 3.33 | 3.59 | 3.19 | 3.25 | 3.26 |
| Leucine | 6.40 | 3.54 | 6.03 | 6.34 | 6.41 |
| Tyrosine | 2.82 | 2.87 | 2.53 | 2.57 | 2.64 |
| Phenylalanine | 4.12 | 4.25 | 3.35 | NA | 4.11 |
| Lysine | 4.76 | 4.55 | 3.92 | 4.08 | 3.92 |
| Cysteine* | 0.5 | 0.24 | 0.36 | 0.25 | 0.25 |
| Methionine* | 0.83 | 0.31 | 0.65 | 0.97 | 0.79 |
| Alanine | 3.53 | 3.92 | 3.51 | 3.59 | 3.69 |
| Aspartic acid | 3.66 | 10.58 | 9.25 | 9.20 | 8.85 |
| Glutamic acid | 16.66 | 18.59 | 16.10 | 15.90 | 15.31 |
| Serine | 4.53 | 4.62 | 4.16 | 4.34 | 4.18 |
| Histidine | 2.20 | 2.45 | 2.03 | 2.32 | 2.35 |
| Glycine | 3.23 | 3.61 | 3.11 | 3.24 | 3.39 |
| Arginine | 6.17 | 7.04 | 5.97 | 8.31 | 5.65 |

Essential amino acids are in bold.
*Cyst(e)ine and methionine are partially oxidized by acid hydrolysis, and thus the values reported are underestimated.
Tryptophan is completely destroyed by acid hydrolysis and is thus not reported in table.

### Example 12: Application of the Developed Process in Other Biomasses

The established process based on okara extraction was tested on other biomasses at the 100 mL scale; the protein recovery and content in the extracted product were determined for each biomass. Protein recovery is determined by comparing the amount of extracted protein with the total protein in the raw biomass. Protein content is determined by comparing the amount of extracted protein to the total weight of the extracted product on dry matter basis. In order to increase protein yield, for the extractions of distillers' dried grains (DDG) and canola meal, the pre-treatment pH was raised to pH 11. The other steps and other samples followed the procedure described above. For all materials tested, the enzymatic process increased the protein recovery significantly as shown in Table 8. Compared to non-enzyme control, the greatest increase in protein recovery was seen in DDG (40% up to 74%) followed by canola meal (65% up to 87%). In terms of protein content in the extracted product, DDG and canola meal showed the largest increases, whereas slight increases were obtained for flax and soybean.

TABLE 8
Protein recovery and content in extracts from different
biomasses obtained using the process described herein
Extraction Protein Yield and Recovery

| | | Recovery | Protein |
|---|---|---|---|
| | Enzyme | (% protein) | % |
| Soybean Meal | − | 69.16% ± 3.66% | 55.67% ± 1.22% |
| | + | 79.07% ± 2.63% | 57.64% ± 1.06% |
| DDG | − | 40.24% ± 3.11% | 30.47% ± 0.31% |
| | + | 74.28% ± 0.04% | 35.74% ± 1.92% |
| Canola Meal | − | 65.00% ± 8.12% | 41.75% ± 2.52% |
| | + | 87.14% ± 2.97% | 45.16% ± 5.74% |
| Flax Meal | − | 64.24% ± 3.00% | 47.05% ± 2.10% |
| (defatted) | + | 71.82% ± 1.02% | 49.95% ± 0.24% |
| Hemp Hearts | − | 68.11% ± 1.32% | 73.54% ± 0.57% |
| | + | 78.59% ± 7.93% | 73.41% ± 0.40% |
| Whole Ground | − | 40.02% | 73.94% |
| Hemp | + | 49.41% | 73.69% |

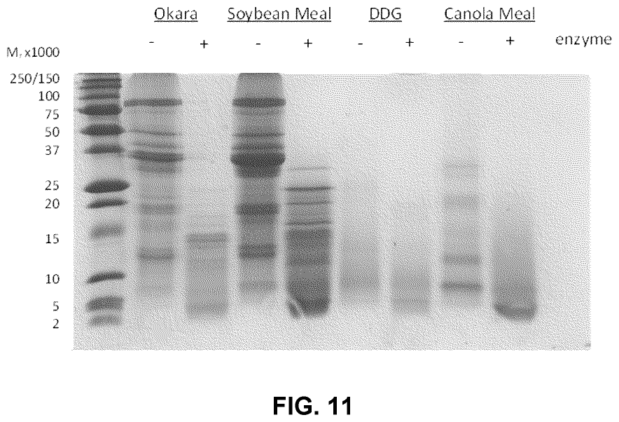

In order to determine if the previously described process mostly based on okara could be used to hydrolyze other biomasses; small-scale extractions were performed with protease E1 on okara, soybean meal, DDG and canola meal. For each biomass, the supernatants with and without enzyme were analyzed side-by-side on a 15% acrylamide gel. As is seen in FIG. 11, there was a clear conversion from larger to smaller molecular weight material when the various materials were incubated with the enzyme. For okara, the majority of proteins were hydrolyzed to smaller than 15 kDa peptides, for soybean meal, mostly under 25 kDa, for DDG, mostly under 10 kDa, and for canola meal, mostly under 10 kDa.

The scope of the claims should not be limited by the preferred embodiments set forth in the examples, but should be given the broadest interpretation consistent with the description as a whole.

1. A process for producing a protein- and/or peptide-enriched fraction and a dietary fiber-enriched fraction from a biomass comprising;
a) a pretreatment step of incubating the biomass in an aqueous solution under mild alkaline conditions and at a temperature of about 85° C. or more to obtain an aqueous slurry;
b) an enzyme hydrolysis step of treating the aqueous slurry with a proteolytic enzyme under conditions suitable for the proteolytic enzyme activity; and
c) obtaining a liquid fraction and a solid fraction from the proteolytic enzyme-treated slurry of b),
wherein the liquid fraction is enriched in proteins and/or peptides and the solid fraction is enriched in dietary fibers and wherein the mild alkaline conditions comprise a pH above 7 and not higher than about 11.

2. (canceled)

3. (canceled)

4. The process according to claim 1, where the biomass is in wet or dry form and the process further comprises grinding the biomass prior to step a).

5. (canceled)

6. The process according to claim 1, further comprising defatting the biomass prior to step a).

7. The process according to claim 1, wherein the mild alkaline conditions comprise a pH of about 9 to about 11 or a pH of about 10.

8. The process according to claim 1, wherein step a) is performed at a temperature of about 90° C. to about 100° C.

9. (canceled)

10. The process according to claim 1, wherein step a) is performed for a period of about 15 minutes to about 2 hours, about 30 to about 90 minutes or about 1 hour.

11. (canceled)

12. (canceled)

13. (canceled)

14. The process according to claim 1, wherein step b) is performed for a period of about 15 minutes to about 2 hours, about 30 to about 90 minutes, or about 1 hour at a pH and a temperature that allow the proteolytic enzyme to be active; optionally the pH is about 8 and the temperature is about 55° C.

15. The process according to claim 1, wherein the amount of biomass in the aqueous solution is about 0.5% to about 20% (w/v).

16. The process according to claim 1, wherein the proteolytic enzyme comprises a subtilisin, optionally a subtilisin from Bacillus lichenformis.

17. (canceled)

18. (canceled)

19. The process according to claim 1, wherein the process further comprises heat inactivating the proteolytic enzyme after step b).

20. The process according to claim 19, wherein the inactivating is heat inactivating.

21. (canceled)

22. The process according to claim 1, wherein the process further comprises treating (i) the proteolytic enzyme-treated slurry of b) and/or (ii) the liquid fraction of c), with a solution comprising a divalent cation.

23. The process according to claim 22, wherein the solution comprises at least one of CaCl₂, MgCl₂, MnCl₂, and FeCl₂.

24. The process according to claim 22, wherein the process comprises treating (i) the proteolytic enzyme-treated slurry of b) and/or (ii) the liquid fraction of c) with a solution comprising a divalent cation to precipitate the phytate, and wherein the process further comprises isolating the liquid fraction from the phytate precipitate.

25. The process according to claim 22, wherein the solution comprising a divalent cation is used in an amount of about 1.5 to about 20× equivalents.

26. (canceled)

27. (canceled)

28. The process according to claim 1, wherein the biomass is a grain biomass, a plant biomass, a distillers' dried grains (DDG), a soybean biomass, canola meal or flax seed meal.

29. The process according to claim 28, wherein the biomass is okara.

30. (canceled)

31. The process according to claim 1, further comprising drying the liquid fraction to obtain a protein and/or peptide-rich dry product.

32. The process according to claim 31, wherein the protein and/or peptide-rich dry product has a residual trypsin inhibitor activity which is at least 50% lower than a commercial soy protein concentrate (SPC), wherein the commercial SPC is Arcon® F.

33. (canceled)

34. (canceled)

35. The process according to claim 1, further comprising drying the solid fraction to obtain a fiber-rich dry product.

36. (canceled)

37. A protein and/or peptide-rich dry biomass extract obtained by the process of claim 31 and having the following features:
a) a water solubility of more than 80% over a pH of about 3 to about 11;
b) a protein and/or peptide content of about 40% or more;
c) at least 75% of the proteins and/or peptides in the extract have a molecular weight of less than 20 kDa;
d) a reduced trypsin inhibition activity and phytate content relative to a commercial soy protein concentrate (SPC), wherein the commercial SPC is Arcon® F.

38. (canceled)

39. (canceled)

40. (canceled)

41. (canceled)

42. A method of preparing a drink, cosmetic, food, or feed product comprising (i) performing the process of claim 31 to obtain a protein and/or peptide-rich dry product; and
(ii) incorporating said protein and/or peptide-rich dry product to a drink, cosmetic, food, or feed composition.

43. A method of preparing a food or feed product comprising (i) performing the process of claim 35 to obtain a fiber-rich dry product; and (ii) incorporating said fiber-rich dry product to a food or feed composition.
